(19) United States
(12) Patent Application Publication
(10) Pub. No.: US 2004/0081088 A1
(43) Pub. Date: Apr. 29, 2004

(54) Data transfer time arbitration

(76) Inventors: Charles Edward Schinner, Windsor, CO (US); Miles Kevin Thorland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/280,765

(22) Filed: Oct. 25, 2002

(51) Int. Cl. H04L 12/28

(52) U.S. Cl. 370/229

(57) ABSTRACT

Disclosed are data transfer systems, methods, and programs. One example data transfer method includes determining whether a present time is acceptable to a recipient for transmission of data to the recipient over the telephone line, transmitting the data to a data receiving device of the recipient over the telephone line if the time is acceptable, and delaying transmission of the data if the time is not acceptable. One example data transfer program includes logic configured to determine what time is acceptable to a recipient for transmitting data to a data receiving device of the recipient, logic configured to determine what time is acceptable to a sender for transmitting data to the data receiving device, logic configured to determine a time that is mutually acceptable to the recipient and the sender, and logic configured to facilitate data transmission during the mutually acceptable time.

### FIELD OF THE DISCLOSURE

The present disclosure relates to data transfers. More particularly, the disclosure relates to systems and methods for arbitrating times for data transmissions via a telephone line.

### BACKGROUND

Data is often transferred using telephone -systems generally referred to plain old telephone systems (POTS) as well as wireless telephone systems. For example, many facsimile machines are designed to transfer fax data to a recipient facsimile machine or an appropriate facsimile application that executes on a computing device, such as a personal computer (PC). To cite another example, image data can be transferred over telephone system lines from a server computer to an appropriate viewing device such as the Cieva™ digital picture frame. Other devices adapted for receiving and/or transmitting data are currently being developed. For instance, so-called ePhoto devices are being developed by Hewlett-Packard Company that are configured to receive (and transmit) image data for display on a standard television set.

Such data transfers involve the transmission of various audible tones over the telephone system lines according to predetermined protocols. When a transfer is initiated, the recipient's line rings, the data receiving device is initiated, and various handshaking occurs between the data receiving device and the data sending device in the form of audible tones transmitted back and forth.

Although the sender of data can typically choose when the data transfer will take place, the recipient of the data transfer often has no control over when any given data transfer will occur. Therefore, such data transfers may occur at particularly inopportune times. For example, a data transfer may interrupt the recipient while sleeping with the telephone ringing where the data transfer is initiated either late at night or early in the morning. Alternatively or in addition, a data transfer may tie up the telephone line during a period of time (e.g., peak business hours) in which the data recipient would like to place an outgoing call or receive other calls.

From the above, it can be appreciated that it would be desirable to provide a recipient user with the capability of designating one or more times during which data transfers may, or may not, take place.

### SUMMARY

Disclosed are data transfer systems, methods, and programs. One example data transfer method includes determining whether a present time is acceptable to a recipient for transmission of data to the recipient over the telephone line, transmitting the data to a data receiving device of the recipient over the telephone line if the time is acceptable, and delaying transmission of the data if the time is not acceptable.

One example data transfer program includes logic configured to determine what time is acceptable to a recipient for transmitting data to a data receiving device of the recipient, logic configured to determine what time is acceptable to a sender for transmitting data to the data receiving device, logic configured to determine a time that is mutually acceptable to the recipient and the sender, and logic configured to facilitate data transmission during the mutually acceptable time.

### BRIEF DESCRIPTION OF THE DRAWINGS

The nature of the disclosed data transfer time arbitration can be better understood with reference to the following drawings. The components in these drawings are not necessarily to scale.

FIG. 1 is a schematic view of an embodiment of a system with which data transfer time arbitration can be facilitated.

FIG. 2 is a block diagram of an example embodiment of a data sending device shown in FIG. 1.

FIG. 3 is a block diagram of an example embodiment of a data receiving device shown in FIG. 1.

FIG. 4 is a flow diagram that illustrates an embodiment of operation of the system of FIG. 1 in facilitating data transfer time arbitration.

FIGS. 5A and 5B provide a flow diagram that illustrates an embodiment of operation of a data transfer time arbitration utility data sending device of FIG. 2.

FIG. 6 is a flow diagram that illustrates an embodiment of operation of a data transfer time arbitration utility of the data receiving device of FIG. 3.

### DETAILED DESCRIPTION

Disclosed herein are systems and methods through which users of data sending devices and/or data receiving devices can designate the time(s) at which data are to be sent or received via a telephone system such as a plain old telephone system (POTS) or a wireless telephone system. With these systems and methods, the sender user and/or the recipient user can select time slots that are to be used for data transmission. Where selections have been made by both a sender user and a recipient user, a mutually acceptable time for transmission is determined through the arbitration process.

Example systems for providing data transfer time arbitration are first discussed with reference to the figures. Although these systems are described in detail, it will be appreciated that these systems are provided for purposes of illustration only and that various modifications are feasible. After the example systems have been described, examples of operation of the systems are provided to explain the manners in which data transfer time arbitration can be facilitated.

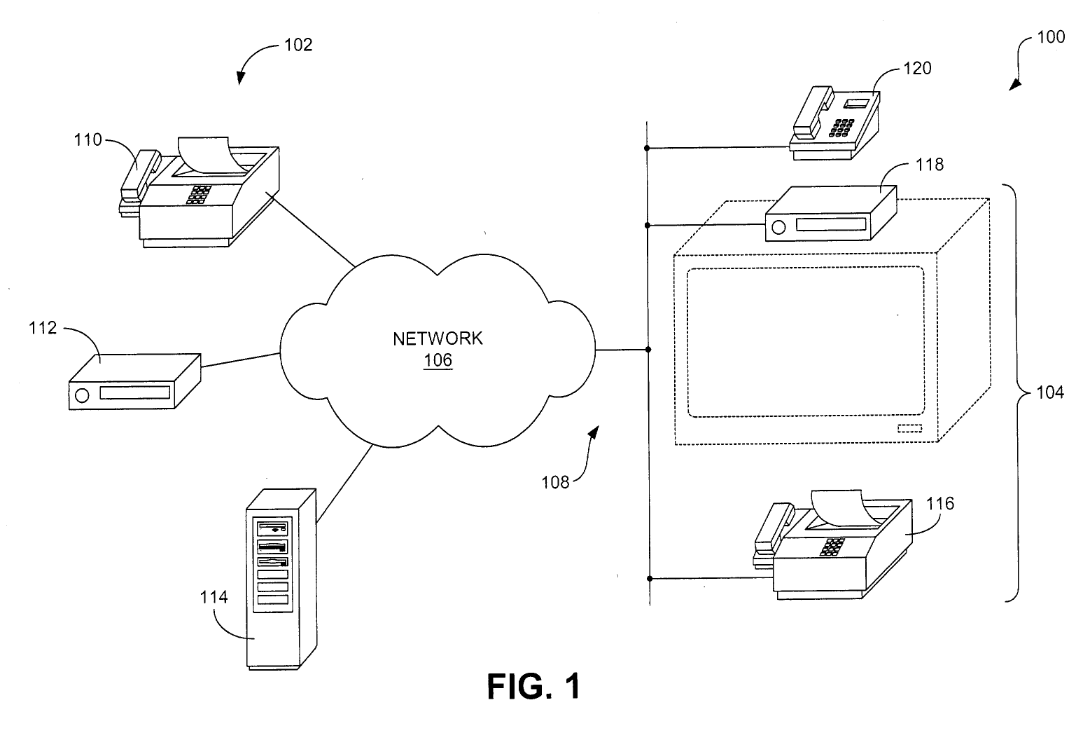

Referring now in more detail to FIG. 1, illustrated is an example system 100 with which data transfers can be achieved and with which data transfer time arbitration can be provided. As indicated in this figure, the system 100 generally comprises one or more data sending devices 102 and one or more data receiving devices 104. Each of the data sending devices 102 is configured to transmit data to one or more of the data receiving devices 104 over a network 106 that is in communication with the recipient's home or office telephone line 108 (either a POTS line or wireless “line”).

By way of example, the data sending devices 102 comprise a facsimile machine 110 that is capable of transmitting scanned data, a data transceiver 112 (e.g., ePhoto device) that is capable of transmitting stored image and/or text data, and a computing device 114 (e.g., personal computer (PC) or server computer) that, through the provision of an appropriate software application and transmission hardware, is capable of transmitting various different types of viewable or printable data. Although these particular data sending devices 102 are shown in FIG. 1 and have been explicitly identified herein, it is to be understood that a data sending device can comprise substantially any device that is capable of transmitting data to a data receiving device 104 via a telephone line.

The data receiving devices 104 comprise substantially any device that is capable of receiving data transmitted from a data sending device 102. For instance, as indicated in FIG. 1, the data receiving devices 104 can comprise a recipient facsimile machine 116 and/or a recipient data transceiver 118 (e.g., ePhoto device) that, as depicted, can be used in conjunction with an appropriate display device such as a television set. Although particular data receiving devices 104 are shown and have been described, persons having ordinary skill in the art will appreciate that alternative data receiving devices are possible. For instance, a data receiving device could comprise the recipient's PC or other computing device where that PC or other computing device comprises software and/or firmware that is configured to receive and display data transmitted from a data sending device 102.

The network 106 typically comprises one or more sub-networks that are communicatively coupled to each other. These networks can include one or more telephone system networks, local area networks (LANs), and/or wide area networks (WANs). In some embodiments, the network 106 may comprise a set of networks that forms part of the Internet. Also shown connected to the recipient's telephone line 108 is a telephone 120 that the recipient may use to make and receive phone calls.

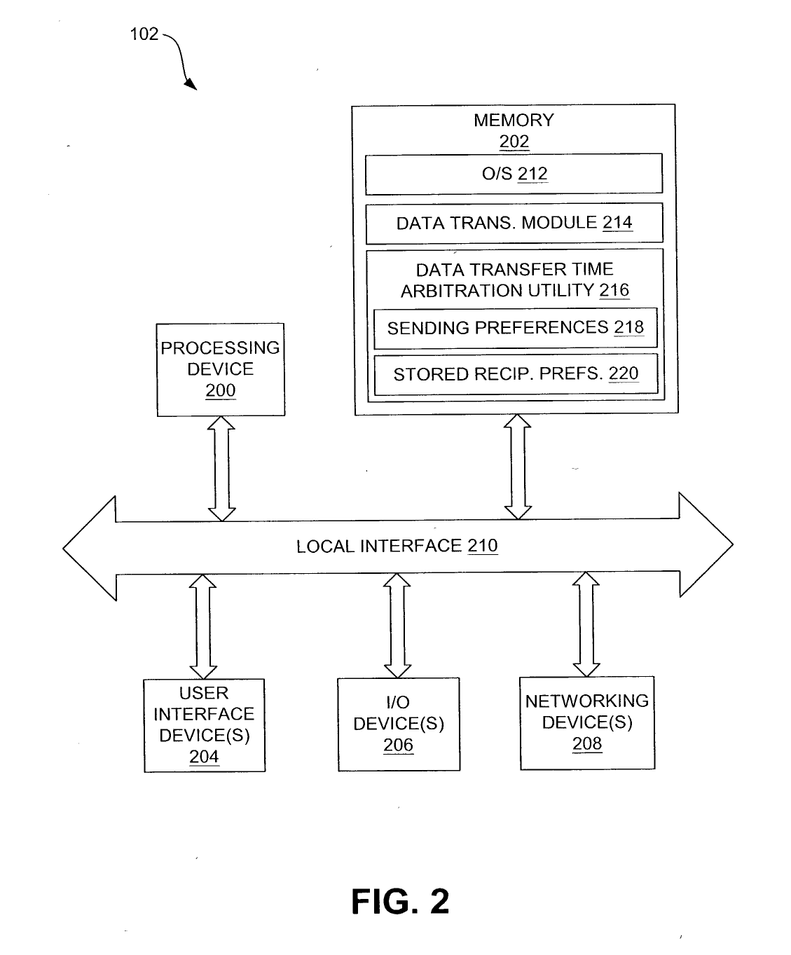

FIG. 2 is a block diagram illustrating an example architecture for the data sending devices 102 shown in FIG. 1. As indicated in FIG. 2, each data sending device 102 can comprise a processing device 200, memory 202, one or more user interface devices 204, one or more I/O devices 206, and one or more networking devices 208, each of which is connected to a local interface 210. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the data sending device 102.

The one or more user interface devices 204 comprise those components with which the sender user can interact with the data sending device 102. Where the data sending device 102 comprises a facsimile machine or an ePhoto device, the user interface devices 204 may comprise one or more keys or buttons and a basic display (e.g., liquid crystal display (LCD)). Where the data sending device 102 comprises a computing device such as a PC or server computer, these components can comprise those typically used in conjunction with a PC, such as a keyboard and mouse.

The one or more I/O devices 206, where provided, comprise components used to facilitate connection of the data sending device 102 to other devices. These devices can, for instance, comprise one or more serial, parallel, small computer system interface (SCSI), universal serial bus (USB), IEEE 1394 (e.g., Firewire™), or personal area network (PAN) connection devices. The networking devices 208 comprise the various components used to transmit (and/or receive) data over the network 106. By way of example, the networking devices 210 include a device that can communicate both inputs and outputs, for instance, a modulator/demodulator (e.g., modem), network card, etc.

The memory 202 normally comprises various programs (software and/or firmware) including an operating system (O/S) 212 that controls the execution of other software/firmware and provides scheduling, input-output control, file and data management, memory management, and communication control and related services. In addition, the memory 202 comprises a data transmission module 214 that is used to package data and otherwise facilitate its transmission to a data receiving device 104. Further provided in memory 202 is a data transfer time arbitration utility 216. As is discussed in greater detail below, this utility 216 is used to ensure that the send time is acceptable to the recipient of the data. Optionally, the arbitration utility 216 can store (or otherwise access) sending preferences 218 which reflect the time periods during which the sender user wishes to send data, as well as recipient preferences 220 that have been, for example, collected from data receiving devices 104.

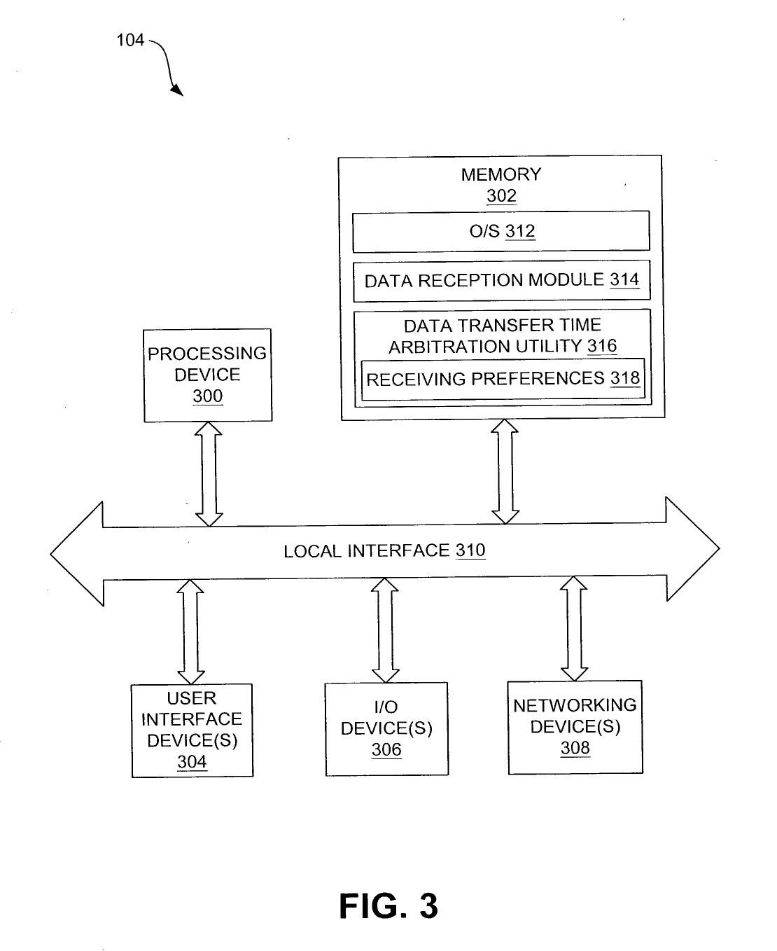

FIG. 3 is a block diagram illustrating an example architecture for the data receiving devices 104 shown in FIG. 1. As indicated in FIG. 3, each data receiving device 104 can have a configuration similar to that of the data sending devices 102. This may particularly be the case where the data receiving device 104 is the same type of device as the data sending device 102 (e.g., where the device comprises an ePhoto device). Accordingly, each data receiving device 104 can comprise a processing device 300, memory 302, one or more user interface devices 304, one or more I/O devices 306, and one or more networking devices 308. Each of these components is connected to a local interface 310 that, by way of example, comprises one or more internal buses.

The memory 302, like memory 202, also includes an operating system 312 that contains the various commands used to control the general operation of the data receiving device 104. In addition, however, the memory 302 comprises a data reception module 314 that is used to unpack data received from data sending devices 102 for viewing, and data transfer time arbitration utility 316 that includes data receiving preferences 318 of the recipient.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

As noted above, the system 100 can be used to ensure that data transfers do not occur during an inopportune time for the data recipient. As is described below, the sender's preferences can also be taken into account in an arbitration process through which a mutually acceptable data transfer time is negotiated. It is to be noted that, the term “arbitration” is used herein to denote determination of an acceptable data transfer time, including situations in which the sender user or the recipient user has not designated (or cannot designate) preferred (or undesired) data transfer time periods. Accordingly, where the sender has not identified a preferred sending time, “arbitration” still occurs in comparing the recipient's preferred time period (e.g., 1 p.m. to 4 p.m.) with the sender's preferred time period (anytime).

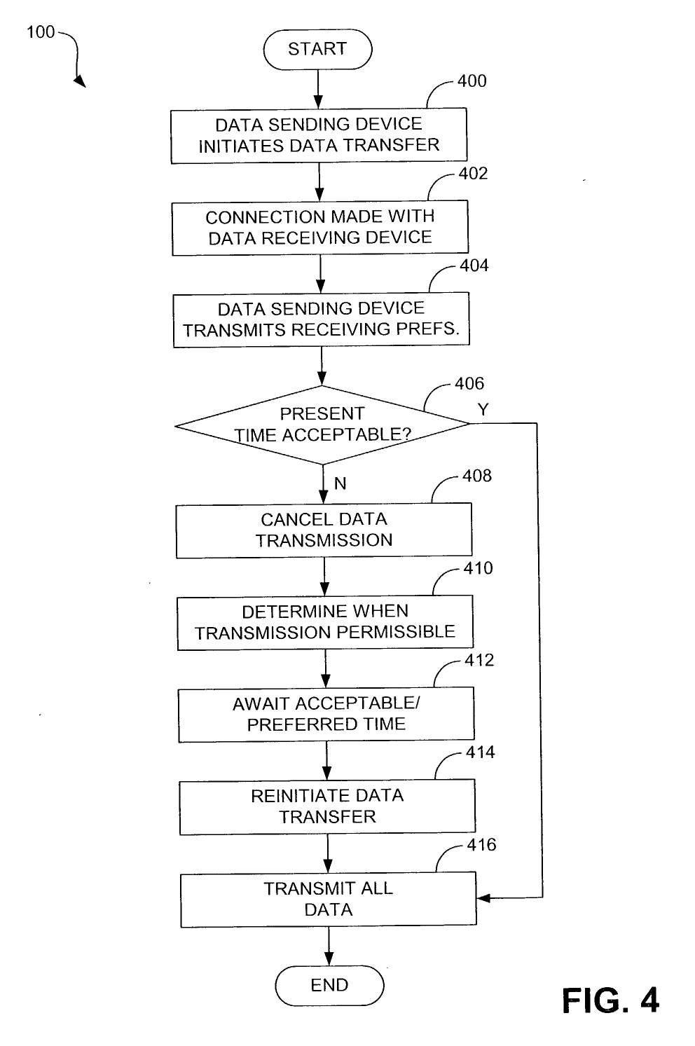

FIG. 4 provides a high-level example of the system 100 operating in facilitating data transfer time arbitration. Beginning with block 400 of this figure, the data sending device 102 initiates a data transfer, presumably upon the initiation of the sender user. By way of example, this initiation occurs under the control of the data transmission module 214. As identified above, the data that are to be transferred can comprise substantially any data that can be viewed and/or printed (depending upon the nature of the data receiving device) and, therefore, may comprise images, text, and the like. Through this initiation, the recipient's telephone rings and, as indicated in block 402, connection is made between the data sending device 102 and the data receiving device 104.

At this point, the data receiving device 104 transmits the recipient user's data receiving preferences 318, as indicated in block 404. These preferences 318 are provided to the data receiving device 104 using, for instance, the user interface devices 304 of the receiving device. Alternatively, the preferences may have been uploaded to the data receiving device 104 using another device such as a PC or other input device. Optionally, these receiving preferences 318 comprise one or more time periods in which data transmission is deemed acceptable to the recipient. For instance, the recipient may specify that it is acceptable to receive data over the telephone line 108 from the hours of 9 a.m. to 4 p.m. Normally, an indication of the recipient's time zone is provided along with the time period information to account for potentially differing time zones of the sender and the recipient. In addition to identifying acceptable time periods, the receiving preferences 318 may include a hierarchy of preferred time periods. For example, the receiving preferences 318 can specify that most preferred for receiving data is the time period between 9 a.m. and 12 p.m. and less preferred, but still acceptable, is the time period between 12 p.m. and 4 p.m.

Referring next to decision block 406, it is determined whether the present time is acceptable for data transmission. This determination is made, for instance by the data transfer time arbitration utility 216 of the data sending device 102 with reference to the receiving preferences 318 received from the data receiving device 104. If the present time is acceptable for data transmission, flow continues down to block 416 described below. If, on the other hand, the present time is not acceptable for data transmission, for example because it would offend the receiving preferences 318 obtained from the data receiving device 104, the data transmission is cancelled, as indicated in block 408. At this point, the data transfer time arbitration utility 216 of the data sending device 102 determines when the data transmission would be permitted, as indicated in block 410. This determination may be made with reference to the receiving preferences 318, to the sending preferences 218, or both. Preferably, the determination is made to determine a time period that is acceptable to both the sender user and the recipient user and, more particularly, determine a time period that is mutually most preferred by both parties, if there is such a time.

Assuming a mutually acceptable and/or most preferred time exists, the data sending device 102, can, as indicated in block 412, await such time and, as indicated in block 414, reinitiate data transfer at that time. Accordingly, with reference to block 416, all data may be transmitted and flow for the session is terminated.

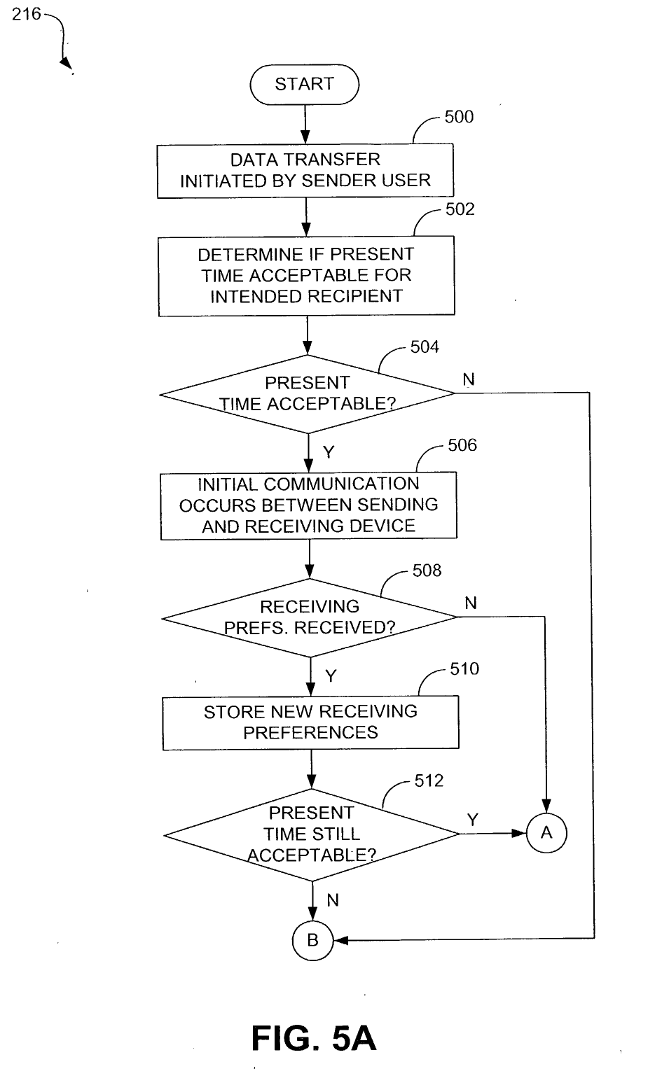

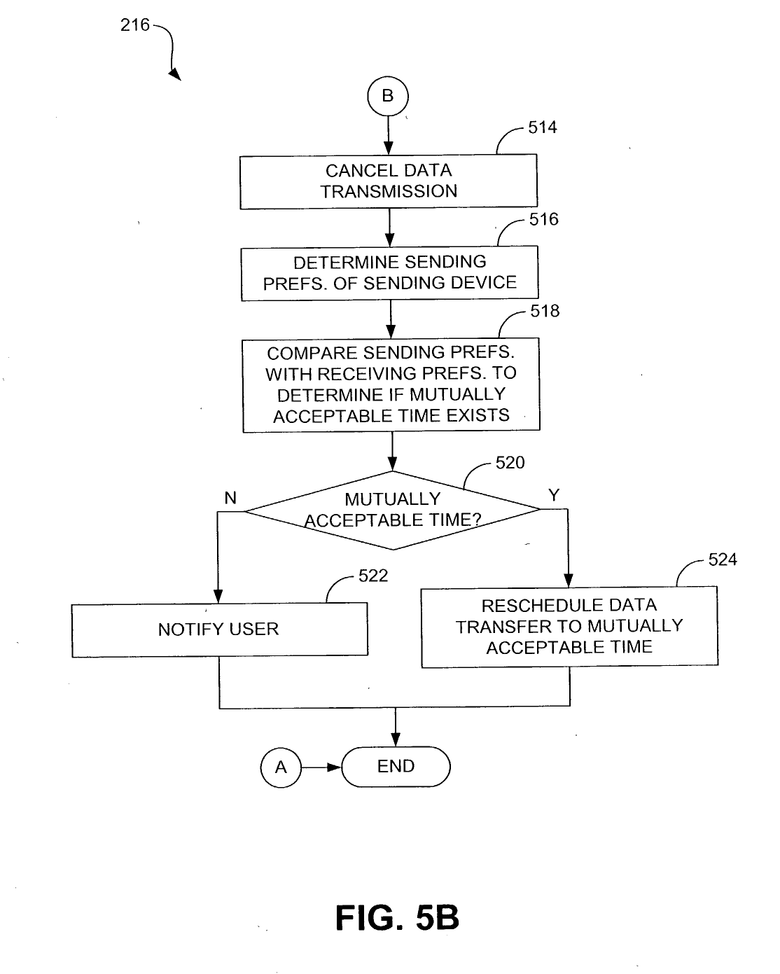

FIGS. 5A and 5B illustrate an example of operation of the data transfer time arbitration utility 216 of the data sending device 102. Beginning with block 500 of FIG. 5A, the data transfer process is initiated by the sender user. Once the transfer process has been initiated, the data transfer time arbitration utility 216 determines whether the time is acceptable for transmission to the intended recipient with reference to the stored recipient preferences 220, as indicated in block 502. Notably, there may only be preferences stored for the intended recipient if they were previously downloaded (e.g., during a previous data transfer). In addition to determining if the time is acceptable for the intended recipient, the arbitration utility 216 can also determine if the time is acceptable for transmission according to the sending preferences 218 that have been stored on the sending device 102. Where the sender user initiates the data transfer during a time that is unacceptable in view of these sending preferences 218, data transmission can be delayed until such time when transmission is mutually acceptable to the sender user and the recipient user. In such a case, the sending device 102 operates in a delay mode. However, for purposes of this discussion, it is assumed that if the sender user initiated the data transfer, immediate data transmission is acceptable to the sender user irrespective of the sending preferences 218. In such a case, the initiation of the data transfer may override the sending preferences 218.

With reference next to decision block 504, if it is determined that the present time is not acceptable in view of the receiving preferences of the recipient, flow continues down to block 512 described below. However, if the time is acceptable, the data transfer continues. If there are no receiving preferences stored (e.g., this is the first data transfer to the intended recipient), the time is presumed to be acceptable. At this point, an initial communication occurs between the data sending device 102 and the data receiving device 104, as indicated in block 506, during which any data receiving preferences of the recipient may be provided to the sending device 102. With reference to decision block 508, if data receiving preferences 318 are received from the data receiving device 104 (new receiving preferences if previous preferences were stored), flow continues to block 510 at which the recipient's receiving preferences 318 are stored as preferences 220. Typically, the receiving preferences 318 are stored along with their relationship with the data receiving device's telephone number or other identifier so that the data transfer time arbitration utility 216 can refer to the receiving preferences before initiating data transmission as described above with reference to block 502. If no receiving preferences are received, the recipient user presumably has not specified any receiving preferences and further arbitration is not necessary. Therefore, flow for the data transfer time arbitration utility 216 is terminated and the data transmission may be completed.

With reference now to decision block 512, it is then determined whether the present time is acceptable for data transmission, this time by referring to the receiving preferences 318 received from the data receiving device 104. If the present time is still acceptable for data transmission, there is no need for further arbitration and flow for the data transfer time arbitration utility 216 is terminated. If, however, the present time is not acceptable, for example if new receiving preferences 318 are received that indicate that the present time is not an acceptable transmission time, flow continues to block 514 of FIG. 5B at which the data transmission is cancelled, at least temporarily, by the data transfer time arbitration utility 216.

Next, the data transfer time arbitration utility 216 determines the sending preferences 218, if any, of the sending device 102, as indicated in block 516. Once these preferences 218 have been determined, they can be compared with the receiving preferences 318 and it is determined whether there are one or more data transmission time periods that are acceptable to both the sender user and the recipient user (i.e., mutually acceptable), as indicated in block 518. Referring to decision block 520, if no such mutually acceptable time exists, the sender user and/or the recipient user is notified of the situation, as indicated in block 522. In the former case, an appropriate message can be presented to the sender user with the user interface devices 304 (e.g., a display) that indicates that no mutually acceptable time currently exists, and the current preferences of the recipient. In the latter case, a communication can be transmitted to the data receiving device 104 while the data sending device 102 and the data receiving device are still connected that also indicates that no mutually acceptable time exists, and the current preferences of the sender. Through this notification, the sender user and/or the recipient user can be invited to change their preferences so as to enable data transmission.

With reference back to decision block 520, if a mutually acceptable time does exist, flow continues to block, 524 at which the data transfer time arbitration utility 216 reschedules the data transmission for a mutual acceptable time. Where most preferred, as opposed to merely acceptable, time periods have been specified by the sender user and/or the recipient user, the utility 216 attempts to satisfy the most preferred time period(s). At this point, flow for the arbitration session is terminated and data transfer may be attempted at a later time.

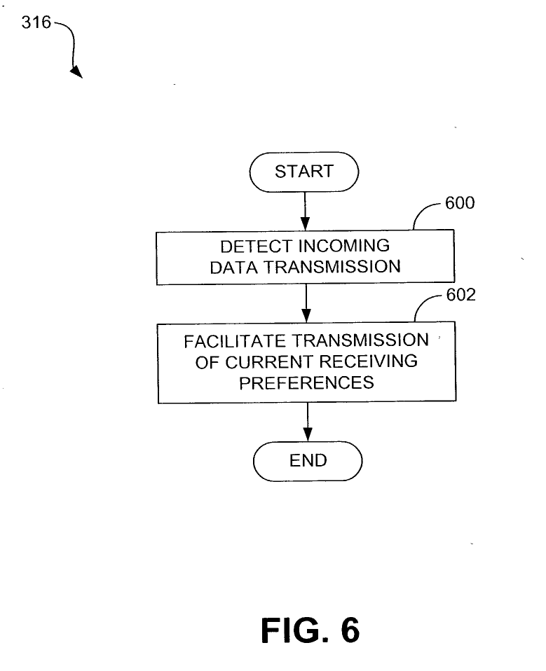

Although the data transfer time arbitration utility 316 of the data receiving device 104 can operate in similar manner to the like-named utility 216 of the data sending device 102 and therefore arbitrate a mutually acceptable time period for data transmission in nearly the identical manner as described above with reference to FIGS. 5A and 5B, in another embodiment the data transfer time arbitration utility 316 can merely provide preferences information to the data sending device to permit the sending device to make the data transmission determinations. FIG. 6 illustrates an example of operation of the data transfer time arbitration utility 316 of the data receiving device 104 in providing preferences information in this manner. Beginning with block 600, the data transfer time arbitration utility 316 detects an incoming data transmission. Upon such detection, the data transfer arbitration utility 316 facilitates the transmission of the current receiving preferences 318 to the data sending device 102, as indicated in block 602, and flow is then terminated.

While particular embodiments have been disclosed in detail in the foregoing description and drawings for purposes of example, it will be understood by those skilled in the art that variations and modifications thereof can be made without departing from the scope of the invention as set forth in the following claims.

What is claimed is:

1. A method for transferring data via a telephone line, comprising:
determining whether a present time is acceptable to a recipient for transmission of data to the recipient over the telephone line;
transmitting the data to a data receiving device of the recipient over the telephone line if the time is acceptable; and
delaying transmission of the data if the time is not acceptable.

2. The method of claim 1, wherein the step of determining whether a present time is acceptable comprises receiving data receiving preferences from the data receiving device.

3. The method of claim 2, further comprising storing the data receiving preferences for future use.

4. The method of claim 2, further comprising determining when data transmission would be acceptable to the recipient by referring to the data receiving preferences.

5. The method of claim 4, further comprising determining when data transmission would be acceptable to the sender and determining a data transmission time that is mutually acceptable to the recipient and the sender.

6. The method of claim 5, further comprising determining a most preferred time to transmit the data.

7. The method of claim 5, further comprising enabling transmission at the mutually acceptable time.

8. The method of claim 1, wherein the step of determining whether a present time is acceptable comprises consulting previously stored data receiving preferences of the recipient.

9. A method for transferring data via a telephone line from a data sending device to a data receiving device, comprising:
receiving data receiving preferences from the data receiving device with the data sending device;
storing the data receiving preferences;
determining what time is acceptable to a recipient for transmitting data to the data receiving device based upon the received data receiving preferences;
determining what time is acceptable to a sender for transmitting data to the data receiving device based upon data sending preferences;
determining a time that is mutually acceptable to the recipient and the sender; and
facilitating data transmission during the mutually acceptable time.

10. The method of claim 9, wherein determining a time that is mutually acceptable comprises determining a time that is most preferred for data transmission.

11. The method of claim 9, further comprising the step of notifying one of the sender and the recipient if it is determined that there is no mutually acceptable time.

12. The method of claim 9, further comprising the step of, prior to receiving data receiving preferences, determining whether a present time is acceptable for transmitting data to the data receiving device based upon previously stored data receiving preferences.

13. A system for transferring data, comprising:
means for receiving data receiving preferences from a data receiving device to which data are to be transmitted;
means for determining what time is acceptable for data transmission to both a sender of the data and an intended recipient of the data; and
means for facilitating data transmission during a time that is acceptable to the sender and the intended recipient.

14. The system of claim 13, further comprising means for notifying one of the sender and the intended recipient if there is no mutually acceptable time.

15. A data transfer time arbitration program stored on a computer-readable medium, comprising:
logic configured to determine what time is acceptable to a recipient for transmitting data to a data receiving device of the recipient;
logic configured to determine what time is acceptable to a sender for transmitting data to the data receiving device;
logic configured to determine a time that is mutually acceptable to the recipient and the sender; and
logic configured to facilitate data transmission during the mutually acceptable time.

16. The program of claim 15, further comprising logic configured to notify one of the sender and the recipient that there is no mutually acceptable time.

17. The program of claim 15, further comprising logic configured to determine, prior to initiating a data transfer, whether a present time is acceptable for transmitting data to the data receiving device.

18. A data transfer time arbitration program stored on a computer-readable medium, comprising:
logic configured to detect an incoming data transmission to a data receiving device; and
logic configured to facilitate transmission of current data receiving preferences of the intended recipient to a data sending device.

19. A data sending device adapted to transmit data to a data receiving device via a telephone line, comprising:
a processor; and
memory that comprises a data transfer time arbitration utility, the utility including logic configured to determine what time is acceptable to a recipient for transmitting data to a data receiving device of the recipient, logic configured to determine what time is acceptable to a sender for transmitting data to the data receiving device, logic configured to determine a time that is mutually acceptable to the recipient and the sender, and logic configured to facilitate data transmission during the mutually acceptable time.

20. The device of claim 19, wherein the memory further includes logic configured to notify one of the sender and the recipient that there is no mutually acceptable time.

21. The device of claim 19, wherein the memory further includes logic configured to determine, prior to initiating a data transfer, whether a present time is acceptable for transmitting data to the data receiving device.
